(19) United States
(12) Patent Application Publication
(10) Pub. No.: US 2013/0321388 A1
(43) Pub. Date: Dec. 5, 2013

(54) LIVE EVENT INFORMATION REPORTING SYSTEM

(71) Applicants: Matthew Locke, Cameron Park, CA (US); Andrew Beal, Cameron Park, CA (US); Megan Peasha, Folsom, CA (US); Steven Montoya, Cameron Park, CA (US)

(72) Inventors: Matthew Locke, Cameron Park, CA (US); Andrew Beal, Cameron Park, CA (US); Megan Peasha, Folsom, CA (US); Steven Montoya, Cameron Park, CA (US)

(73) Assignee: CBS INTERACTIVE INC., San Francisco, CA (US)

(21) Appl. No.: 13/483,748

(22) Filed: May 30, 2012

(51) Int. Cl. G06T 1/00

(52) U.S. Cl. 345/418

(57) ABSTRACT

A live event information reporting system is described. An apparatus may comprise a live event information reporting application operative on a processor circuit to provide user interfaces for reporting and viewing information reported for live events. The live event information reporting application may comprise a context information component operative to access context information associated with one or more live events; a reporting user interface component operative to display a live event reporting user interface, the live event reporting user interface configured to provide the context information and one or more event information elements corresponding to the one or more live events; and a live event information component operative to receive live event information associated with the one or more live events entered via the event information elements. Other embodiments are described and claimed.

### CROSS-REFERENCE TO RELATED APPLICATIONS

This application is related to commonly owned and co-pending U.S. patent application Ser. No. ______, titled “LIVE EVENT INFORMATION MANAGEMENT SYSTEM”, filed on ______, which is incorporated by reference in its entirety.

### BACKGROUND

The number of services providing access to real-time information and personal communications are rapidly expanding. As such, the general public has come to expect instant updates of live events, especially in certain content areas, such as sports, entertainment, and the financial markets. For matters of widespread significance, such as national sporting or news events, media outlets and Internet services are available to communicate real-time information. Major content providers already have the assets in place to cover these events, such as National Football League (NFL®) games, to provide live broadcasts or real-time online scores and game summaries.

However, local interests and events with a more limited following do not have the infrastructure, such as video and broadcast technology and, more importantly, the personnel, to provide live updates. Nonetheless, these local and small audience events, such as high school sports, are often followed by a passionate fan base that seeks real-time information parallel to that provided for nationally covered events. Various content providers, such as web site operators, may benefit from providing real-time information pertaining to local and small audience events, for example, through increased web site traffic, increased online advertising revenue, and building a loyal following drawn from the local and small audience event fan base.

### BRIEF DESCRIPTION OF THE DRAWINGS

FIG. 1 illustrates an embodiment of a live event information reporting system.

FIG. 2 illustrates an embodiment of a first operating environment for a live event information reporting application.

FIG. 3 illustrates an embodiment of a second operating environment for a live event information reporting application.

FIG. 4 illustrates an embodiment of a third operating environment for a live event information reporting application.

FIG. 5 illustrates an embodiment of a fourth operating environment for a live event information reporting application.

FIG. 6 illustrates an embodiment of a fifth operating environment for a live event information reporting application.

FIG. 7 illustrates an embodiment of a sixth operating environment for a live event information reporting application.

FIG. 8 illustrates an embodiment of a seventh operating environment for a live event information reporting application.

FIG. 9 illustrates an embodiment of a eighth operating environment for a live event information reporting application.

FIG. 10 illustrates an embodiment of a ninth operating environment for a live event information reporting application.

FIG. 11 illustrates an embodiment of a tenth operating environment for a live event information reporting application.

FIG. 12 illustrates an embodiment of a first logic flow.

FIG. 13 illustrates an embodiment of a second logic flow.

FIG. 14 illustrates an embodiment of a third logic flow.

FIG. 15 illustrates an embodiment of a computing architecture.

FIG. 16 illustrates an embodiment of a communications architecture

### DETAILED DESCRIPTION

User demand for access to real-time information is not being met for a large number of live events. Large media broadcasters and content providers such as the Cable News Network (CNN®), Yahoo!®, CBS Broadcasting Inc. (e.g., CBS Sports®), and the Entertainment and Sports Programming Network (ESPN®) provide real-time information directed towards news and sports events having widespread appeal and national audiences. These and other similar organizations have limited resources and only dedicate their infrastructure, technology, and personnel to cover popular events that will earn an adequate return on their investment. As a result, local and small audience events are not covered in a manner that provides users with access to real-time information. Exemplary local and small audience events include regional sporting events and events having a limited following compared to popular sporting events such as Major League Baseball® (MLB®) games, including high school sports, college sports (e.g., non-Division I college sports), and small audience sports such as swimming, diving, and cycling.

Although local and small audience events do not have widespread, national audiences, they are often followed by dedicated, passionate fan bases that seek real-time information in a manner similar to that provided for events of mass appeal. This is especially true for local school sports, as evidenced by the popularity of content providers involved in covering these events, such as MaxPreps®, an online content provider dedicated to high school sports across the United States. For example, a fan of a local high school football team may seek to have real-time game information for a rival team, especially if that team is playing in a game with potential playoff implications for the local high school football team. Although regional media outlets may cover certain aspects of local sporting events, they do not provide real-time information; to the contrary, their coverage is generally devoted to broadcasting scores of completed games. In addition, the infrastructure and personnel required to provide real-time information for local sporting events is cost prohibitive and not practical at that level. As such, it would be beneficial to provide an efficient, accurate, and cost-effective technique for providing real-time information for local and small audience events.

Accordingly, various embodiments are generally directed to techniques for real-time reporting of live events. Some embodiments are particularly directed to a user interface specifically configured to provide an efficient process for a user to enter real-time information via a mobile computing device while attending a particular event. For example, a user interface may be customized for reporting updated scores of a football game, with reporting elements specific for football, including without limitation touchdowns, field goals, and pass play information. The reported information may be transmitted to a content consumer, such as a database, an Internet content provider, a media service, or some combination thereof. In this manner, members of the general public may provide substantially real-time information for events, such as local and small audience events that may not be covered live otherwise, and this real-time information may be provided to users in substantially real-time, for example, on a web page accessible by a browser application.

User interfaces configured according to embodiments provide for simple and efficient entry of real time information for a particular event, increasing accuracy and the likelihood of user participation, as well as providing standard data formats for content consumers. This significantly reduces the time and effort required to cover a wide range of local and small audience events, thereby enhancing convenience, user experience, and the availability of information.

With general reference to notations and nomenclature used herein, the detailed description which follows may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Various embodiments also relate to apparatus or systems for performing these operations. These apparatus may be specially constructed for the required purpose or may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

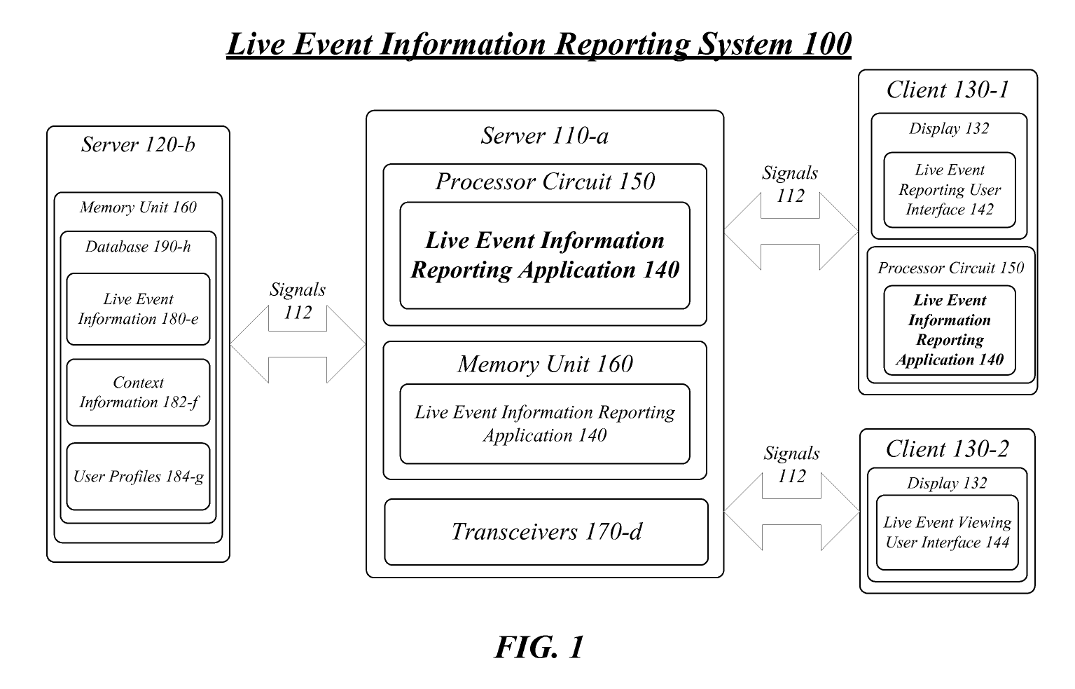

FIG. 1 illustrates a block diagram for a live event information reporting system 100. In one embodiment, the live event information reporting system 100 may comprise a computer-based system comprising a server 110-a. The server 110-a may comprise, for example, a processor circuit 150, a memory unit 160, and one or more transceivers 170-d. The server 110-a may further have installed a live event information reporting application 140. The memory unit 160 may store an unexecuted version of the live event information reporting application 140. Although the live event information reporting system 100 shown in FIG. 1 has a limited number of elements in a certain topology, it may be appreciated that the live event information reporting system 100 may include more or less elements in alternate topologies as desired for a given implementation.

It is worthy to note that “a,” “b,” “c” and similar designators as used herein are intended to be variables representing any positive integer. Thus, for example, if an implementation sets a value for b=3, then a complete set of servers 120-b may include servers 120-1, 120-2, and 120-3. The embodiments are not limited in this context.

In various embodiments, the live event information reporting system 100 may comprise multiple computing devices, such as servers 110-a, 120-b and clients 130-c. Some examples of a computing device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In one embodiment, for example, servers 110-a and 120-b may be implemented as a web server and a network server, respectively, accessible over a network, such as the Internet. The client 130-c may be implemented as a desktop computer or a mobile device having a portable power supply and wireless communications capabilities, such as a laptop computer, handheld computer, tablet computer, smart phone, gaming device, consumer electronic, or other mobile device. The embodiments are not limited to these examples, however, and any servers 110-a, 120-b and clients 130-c may be used as desired for a given implementation. The servers 110-a may communicate with other computing devices 120-b, 130-c using communications signals 112 via the transceivers 170-d. The embodiments are not limited in this context.

In various embodiments, the live event information reporting system 100 may comprise a processor circuit 150. The processor circuit 150 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processor circuit 150.

In various embodiments, the live event information reporting system 100 may comprise a memory unit 160. The memory unit 160 may store, among other types of information, the live event information reporting application 140 or one or more databases 190-h. The memory unit 160 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Users may access a live event reporting user interface 142 and a live event viewing user interface 144 through display 132 of a client 130-1, 130-2. The display 132 may comprise any digital display device suitable for the one or more clients 130-c. For instance, the display 132 may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying a user interface 142, 144 to a user of the one or more clients 130-c. The display 132 may further include some form of a backlight or brightness emitter as desired for a given implementation.

In various embodiments, the servers 110-a may comprise one or more transceivers 170-d. Each of the transceivers 170-d may be implemented as wired transceivers, wireless transceivers, or a combination of both. In some embodiments, the transceivers 170-d may be implemented as physical wireless adapters or virtual wireless adapters, sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 170-d may comprise or implement various communication techniques to allow the servers 110-a to communicate with other electronic devices, such as the servers 120-b and the clients 130-c. For instance, the wireless transceivers 170-d may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the servers 110-a may implement different types of transceivers 170-d. Each of the transceivers 170-d may implement or utilize a same or different set of communication parameters to communicate information between various electronic devices. In one embodiment, for example, each of the transceivers 170-d may implement or utilize a different set of communication parameters to communicate information between the servers 110-a and one or more remote devices, such as remote servers 120-b and remote clients 130-c. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the transceivers 170-d. The embodiments are not limited in this context.

In one embodiment, for example, the transceiver 170-d may comprise a radio designed to communicate information over a wireless local area network (WLAN), a wireless metropolitan area network (WMAN), a wireless wide area network (WWAN), or a cellular radiotelephone system. The transceiver 170-d may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the transceiver 170-d may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

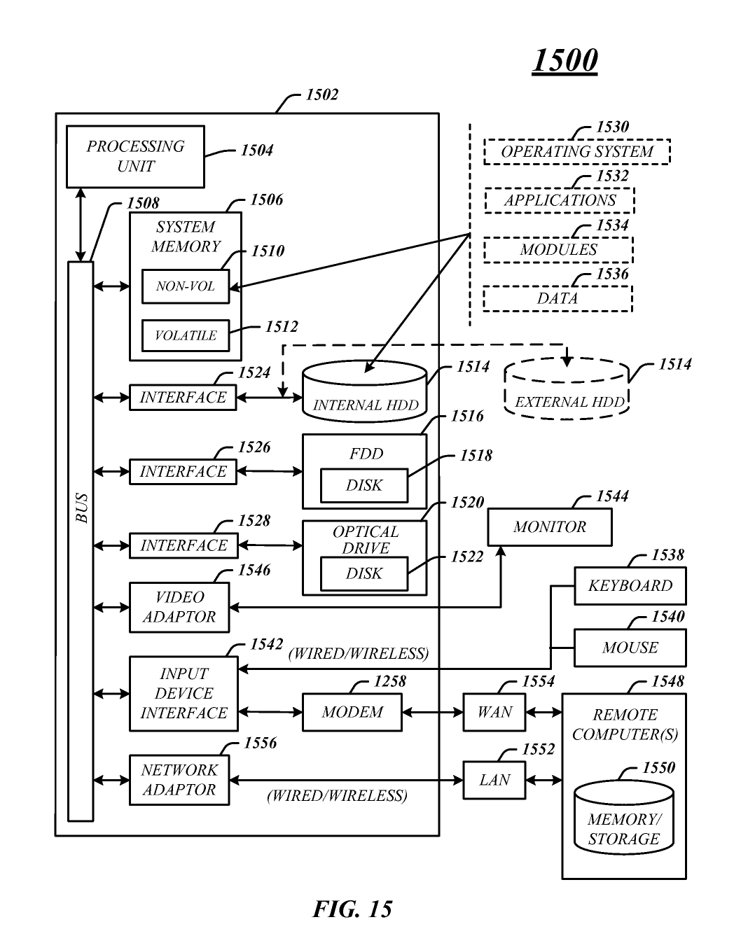

Although not shown, the servers 110-a, 120-b and clients 130-c may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIG. 15. The embodiments, however, are not limited to these examples.

In the illustrated embodiment shown in FIG. 1, the processor circuit 150 may be communicatively coupled to the transceiver 170-d and the memory unit 160. The memory unit 160 may store a live event information reporting application 140 arranged for execution by the processor circuit 150 to present a user interface 142, 144 to one or more clients 130-c through communication signals 112 via the transceivers 170-d. The servers 120-b and clients 130-c may implement similar elements as the servers 110-a, including a processor circuit 150, a memory unit 160, and transceivers 170-d. For example, servers 120-b may be comprised of a memory unit 160 storing data such as live event information 180-e, context information 182-f, user profiles 184-g, or some combination thereof in one or more databases 190-h. Clients 130-c may be comprised of a processor circuit 150 storing an unexecuted version of the live event information reporting application 140 and a memory unit 160 for storing, at least temporarily, live event information 180-e, context information 182-f, or both.

The live event information reporting application 140 may generally provide features to present a live event reporting user interface 142 configured to allow a user to enter live event information 180-e corresponding to a live event being attended by the user. More particularly, the live event reporting interface 142 may be configured specifically for the reporting of live event information 180-e characteristic for the type of live event, such as a particular sporting event, including, but not limited to, football, basketball, baseball, softball, ice hockey, field hockey, soccer, wrestling, and lacrosse sporting events. In a non-limiting example, a user may access the live event reporting user interface 142 utilizing a smart phone client 130-c device while attending a local high school football game. While at the game, the user may report live event information 180-e such as score updates, scoring plays, weather, kickoff, timeouts, penalties, game time, current quarter, attendance, and any other information relevant to the contest.

Certain content displayed on the live event reporting interface 142 and the live event viewing interface 144 may be specified by context information 182-f. Illustrative and non-restrictive examples of context information 182-f for a sporting event may include team names, game date and time, player names, positions, jersey numbers, and a unique game identifier. The context information 182-f may be stored on a server 110-a, 120-b and communicated to the live event information reporting application 140 through communication signals 112.

Live event information 180-e entered via the live event reporting user interface 142 may be transmitted via communication signals 112 to the live event information reporting application 140 operating on the server 110-a. According to embodiments, the live event information reporting application 140 may operate to store the live event information 180-e in a memory unit 160 or on another server 120-b or to present the live event information 180-e, in combination with any associated context information 182-f, on a display 132 of a client 130-c computing device through a live event viewing user interface 144. In one embodiment, clients 130-c may access the live event viewing user interface 144 through a thin-client application and any associated thin-client hardware accessible by the client 130-c, including, but not limited to, ultra-thin client, web thin client, and mobile thin client implementations, or through a web browser user interface, including without limitation Microsoft® Internet Explorer®, Mozilla® Firefox®, Apple® Safari®, and Google Chrome™ browser applications.

Users may register with the live event information reporting system, for example, through the creation of user profiles 184-g associated with login credentials (i.e. user name and password) and user profile information (e.g., name, address, phone number, email address, historical data). In one embodiment, users may access the live event information viewing user interface 144 to follow the progress of a live event, such as a particular baseball game; however, only one registered user may access the live event reporting interface 142 for the particular event, for example, to ensure that there is only one (or some other limited number) reporter or score keeper for each particular event.

In one embodiment, the clients 130-c may execute a version (e.g., a client version or mobile application version) of the live event information reporting application 140 through a processor circuit 150 resident on one of the clients 130-c. As such, the version of the live event information reporting application 140 operating on the servers 110-a may communicate with the version of the live event information reporting application 140 operating on the client to, inter alia, obtain user credentials, to receive live event information 180-e, and to provide context information 182-f.

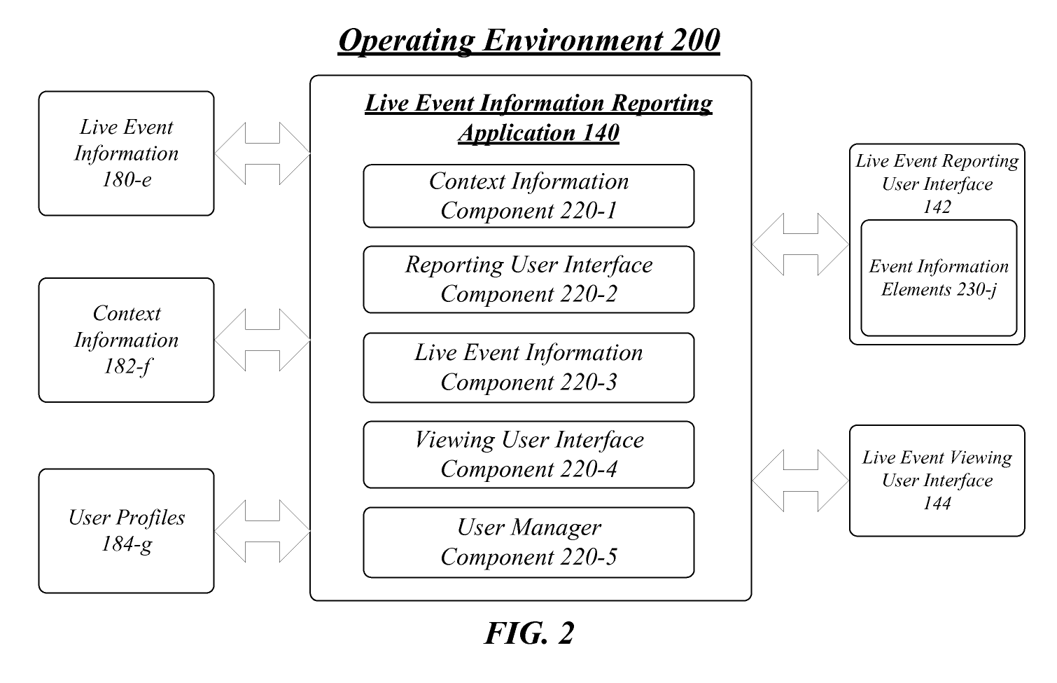

Particular aspects, embodiments and alternatives of the live event information reporting system 100 and the live event information reporting application 140 may be further described with reference to FIG. 2.

FIG. 2 illustrates an embodiment of an operating environment 200 for the live event information reporting system 100. More particularly, the operating environment 200 may illustrate a more detailed block diagram for the live event information reporting application 140.

As shown in FIG. 2, the live event information reporting application 140 may comprise various components 220-i. As used in this application, the term “component” is intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In the illustrated embodiment shown in FIG. 2, the live event information reporting application 140 may comprise a context information component 220-1, a reporting user interface component 220-2, a live event information component 220-3, a viewing user interface component 220-4, and a user manager component 220-5. Although the live event information reporting application 140 shown in FIG. 2 has only four components in a certain topology, it may be appreciated that the live event information reporting application 140 may include more or less components in alternate topologies as desired for a given implementation. The embodiments are not limited in this context.

The context information component 220-1 may generally access context information 182-f associated with one or more live events stored on one or more servers 110-a, 120-b. The context information 182-f may be any information associated with a live event and any participants thereof. Non-limiting examples of context information 182-f include team names, geographic locations, event dates and times, participant names, positions, jersey numbers, statistics, and unique event identifiers. The live event information reporting application 140 may utilize the context information component 220-1 to obtain context information 182-f for display on the live event reporting user interface 142 and the live event viewing user interface 144. For instance, when a user accesses a live event reporting interface 142 configured for a particular sporting event, the live event reporting interface 142 may be populated with context information 182-f content indicating the team names, game location, and the scheduled start time of the game.

In one embodiment, a server 110-a, 120-b may store context information 182-f pertaining to one or more particular organizations or participants that may be used in combination with live event information 180-e to provide additional related context information 182-f, for example, for display on the live event viewing user interface 144. For instance, a database operative on a server 110-a, 120-b accessible by the context information component 220-1 may store a baseball team roster comprised of player names and corresponding jersey numbers. Responsive to a user reporting that a player with a certain jersey number has scored a run reported via the live event reporting user interface 142, the context information component 220-1 may access the baseball team roster to locate the player name associated with the jersey number. As described below, the player name and jersey number may be displayed, for example, as part of a scoring summary, on the live event viewing interface 144.

The reporting user interface component 220-2 may generally provide a live event reporting user interface 142 configured to allow a user to enter live event information 180-e for a live event. In one embodiment, the reporting user interface component 220-2 may provide a live event reporting user interface 142 accessible from a display 132 of a client 130-c, for example, a laptop computer, smart phone, or tablet computing device. The reporting user interface component 220-2 may operate to facilitate the transmission of live event information 180-e entered via the live event reporting user interface 142 to the live event information reporting application 140 operating on the server 110-a.

The live event reporting interface 142 may be comprised of one or more event information elements 230-j configured to provide content and to facilitate the reporting of live event information 180-e. According to embodiments, event information elements 230-j may consist of text, images, virtual selection buttons, text boxes, radio buttons, toggle buttons, voice data receivers, and any other form of data entry component. In one embodiment, the event information elements 230-j may be comprised of multiple virtual selection buttons configured to indicate a team and the value of a scoring play completed by that team in a live sporting event. For example, for a basketball game, the event information elements 230-j may be comprised of virtual selection buttons for selecting a particular team and virtual buttons for selecting the value of the scoring play (e.g., 1, 2, or 3 points).

The live event information component 220-3 may generally operate to receive and manage live event information 180-e reported via a live event reporting user interface 142. The live event information component 220-3 may transmit reported live event information 180-e for storage in one or more databases 190-h and may access live event information 180-e to feed content requests initiated by the live event reporting user interface 142 or the live event viewing user interface 144. For example, if a user reports via a live event reporting user interface 142 a score update (i.e., live event information 180-e) for a live event football game, the live event information component 220-3 may receive the score update and store the live event information 180-e in a database 190-h. In another example, a live event viewing user interface 144 may request live event information 180-e from the live event information component 220-3 for a particular live event basketball game (e.g., a request to refresh the web page displaying the live event viewing user interface 144). The live event information component 220-3 may operate to retrieve and communicate the requested live event information 180-e (e.g., updated score information) within the live event information reporting application 140 for display on a live event reporting user interface 142 or live event viewing interface 144. In one embodiment, the information stored in the database 190-h may be utilized as a data source for one or more external applications or systems, such as a system configured to track, organize, report, and edit statistics for one or more teams, leagues, conferences or other such entities. For instance, the live event information reporting application 140 may operate as a scoring system for a statistics tracking and reporting system or a live event information management system.

The viewing user interface component 220-4 may generally operate to provide a live event viewing user interface 144 for displaying live event information 180-e and context information 182-f for one or more live events. The live event viewing user interface 144 may operate to provide user access to the status of a live event in substantially real-time. For example, a user may access a live event viewing user interface 144 as provided by the viewing user interface component 220-4 and select to view a local high school football event. The live event viewing user interface 144 may display content showing live event information 180-e and context information 182-f for the local high school football event in substantially real-time, including without limitation team names, game location, current score, score by quarter, scoring summaries (e.g., scoring plays, scoring play participants, type of play, yardage, and time of play), game time information, weather and field conditions, penalties, and turnovers.

In one embodiment, the reporting user interface component 220-2 or the viewing user interface component 220-4 may access live event information 180-e for a particular live event through data requests communicated to the live event information component 220-3 and context information 182-f through data requests communicated to the context information component 220-1. In another embodiment, the reporting user interface component 220-2 or the viewing user interface component 220-4 may be configured to directly access the live event information 180-e and context information 182-f stored in one or more databases 190-h.

The user manager component 220-5 may generally operate to facilitate user access to the live event information reporting application 140. Users may register with the live event information reporting system 100 or with another system accessible by the live event information reporting application 140. In one embodiment, registered users are registered with the live event information reporting system 100 and associated with user profiles 184-g stored in a database 190-h on a server 110-a, 120-b accessible by the user manager component 220-5. The user profiles 184-g may be comprised of information utilized to identify a registered user and to manage user interaction with the live event information reporting application 140, including, but not limited to, username, password, name, address, email address, and user history information.

In one embodiment, the number of users accessing the live event information reporting system 100 may not be limited. As such, multiple users, such as in a crowdsourcing arrangement, may simultaneously report live event information, including, without limitation, scores, commentary, text, differing viewpoints (e.g., different perspectives on a particular play or participation in a debate), or combinations thereof. In another embodiment, the live event information reporting application 140 may limit the number of users reporting live event information 180-e for a particular event. For example, the live event reporting application 140 may operate to only present one user with a live event reporting user interface 142 for each event. In this manner, the live event reporting application 140 may be utilized to control the accuracy, consistency, and cohesiveness of the live event information 180-e being submitted to the live event information reporting system 100. In one embodiment, the user manager component 220-5 may be configured to track the number of live events reported by a particular user as well as certain quality characteristics, such as completeness, accuracy, and amount of supplied information (e.g., number and amount of detail of scoring summaries). As such, users with more experience, higher quality characteristics, or some combination thereof may be preferentially granted access to the live event reporting interface 142. Embodiments are not limited in this context.

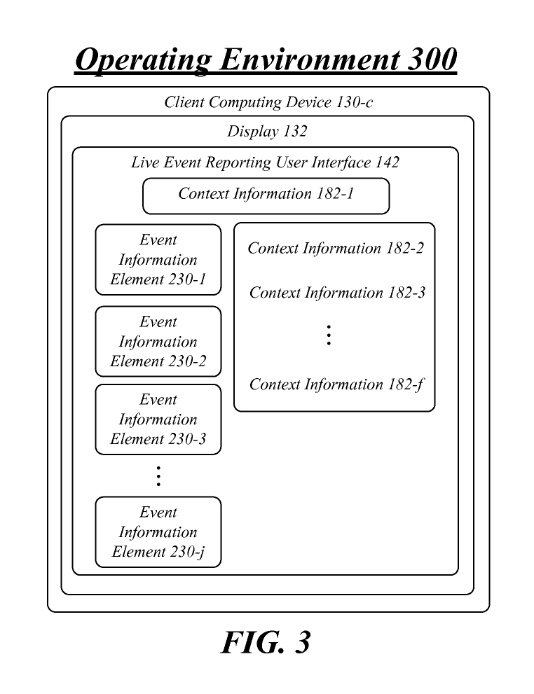

FIG. 3 illustrates an embodiment of an operating environment 300 for the live event information reporting system 100. More particularly, the operating environment 300 may illustrate an exemplary live event reporting user interface 142 configured according to an embodiment. As shown in FIG. 3, the live event reporting user interface 142 may be displayed on a display 132 of a client 130-c computing device. For example, the client 130-c computing device may be any form of computing device capable of displaying and interacting with the live event reporting user interface 142 accessible by a user attending a live event, including, but not limited to, smart phones, tablet computing devices, personal digital assistants (PDAs), laptop computers and various forms of personal computers (PCs). In one embodiment, the live event reporting user interface 142 may be a web page accessible through a web browser or thin client from the client 130-c. In another embodiment, the live event reporting user interface 142 may be comprised of a GUI of a version of the live event information reporting application 140 operating on the client 130-c, such as a client application or a mobile application (e.g., mobile “app”).

The live event reporting user interface 142 may present content comprised of context information 182-1, 182-2, 182-3, 182-f and event information elements 230-1, 230-2, 230-1. The context information 182-1, 182-2, 182-3, 182-f may be comprised of information associated with the live event, such as the event name, team and team member participant names, location, and date and time information. For example, context information 182-1 may consist of the team names competing in a live sporting event, while context information 182-2, 182-3, and 182-f may be comprised of team member names included as part of scoring summary content for the live sporting event. The context information 182-1, 182-2, 182-3, 182-f may be obtained from a database 190-h accessible by the live event information reporting application 140 presenting the live event reporting user interface 142. As such, when a user accesses the live event reporting user interface 142, the context information may be automatically populated for presentation on the display 132.

The event information elements 230-1, 230-2, 230-3, 230-j may be configured to provide data entry of live event information 180-e. For example, event information elements 230-j may be presented as virtual selection buttons, radio buttons, toggle buttons, text boxes, sliders, voice recording elements, or any other component capable of providing entry of live event information 180-e as described herein. For example, the live event reporting user interface 142 may be configured for a basketball sporting event, wherein event information element 230-1 may be a selection button configured to indicate a 3-point basket and event information element 230-2 may be a selection button configured to indicate a 2-point basket. Other event information elements 230-j may be used separately, in combination, or in succession with other event information elements 230-j. For instance, a user may indicate that a particular team scored a 2-point basket by selecting a button for the team, selecting a button to indicate that number of points scored, and a third button to update the score for the team and with the number of points selected through the event information elements 230-j.

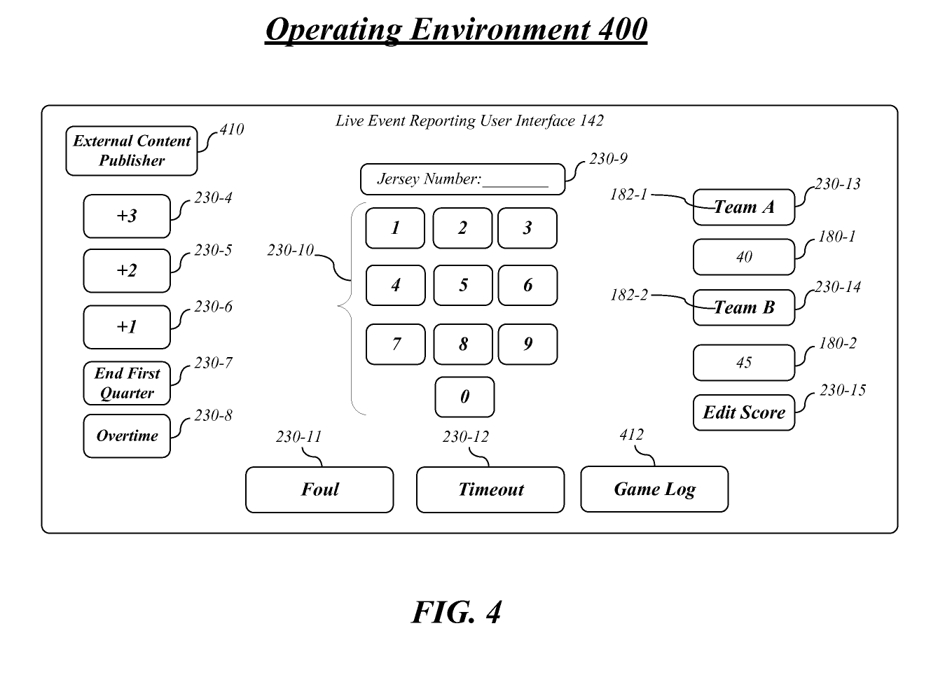

According to embodiments, the live event reporting user interface 142 may be comprised of multiple pages or screens, for example, a main page or screen and a number of sub-pages or sub-screens. Selection of an event information element 230-j may present a sub-page or sub-screen displaying further data entry options. For example, an event information element 230-3 may indicate that a foul has been committed during a basketball sporting event and may invoke presentation of a sub-page displaying event information elements 230-j allowing data entry pertaining to the foul, including, but not limited to, the type of foul, time remaining in the quarter, and the team, jersey number, and number of fouls of the player who committed the foul. FIGS. 4-10 provide example embodiments of live event reporting user interfaces 142 and sub-pages thereof, which are illustrative and non-restrictive, as any user interface configuration capable of operating according to embodiments is contemplated herein.

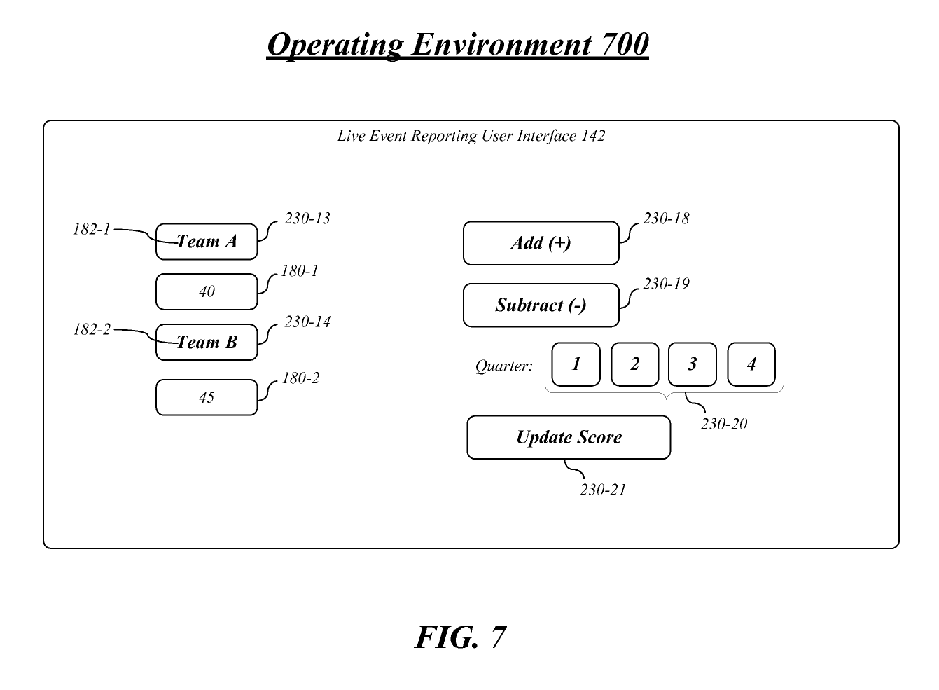

FIG. 4 illustrates an embodiment of an operating environment 400 for the live event information reporting system 100. More particularly, the operating environment 400 may illustrate an exemplary live event reporting user interface 142 for a basketball sporting event. The live event reporting user interface 142 depicted in FIG. 4 may be comprised of context information 182-1, 182-2 providing the names of the teams competing in the game. The score for each team 180-1, 180-2 may be provided based on the live event information 180-e recorded for the game. A user may enter scoring information by selecting an event information element 230-4, 230-5, 230-6 indicating the number of points for the scoring play and selecting the scoring team 230-13, 230-14 to award the indicated number of points to the selected team. For each score, a user may enter a jersey number 230-9 of the scoring player, for example, using number input elements 230-10. Data entry formats are not limited to those depicted in FIG. 4. For example, embodiments may be configured to provide an event information element 230-h for entering a jersey number 230-9, wherein selecting the jersey number 230-9 element may invoke a popup window or other interface displaying a set of number input elements 230-10 having more or less input elements than shown in FIG. 4. The live event reporting user interface 142 may provide event information elements 230-11, 230-12 to enter live event information 182-f pertaining to timeouts and fouls that occur during the game. An edit score 230-15 selection may be provided on the live event user interface 142 to edit a score for a live event, for example, if a scoring event was missed or erroneously entered. A more detailed description of editing a score for a live event is provided in reference to FIG. 7.

The live event reporting user interface 142 may display additional GUI elements, such as a game log 412 and external content publisher 410 elements. In one embodiment, selection of the game log 412 element may present a user with events that have occurred during the game, such as scoring summaries, timeouts, and fouls based on the live event information 180-e entered during the game. In another embodiment, selection of the external content publisher 410 element may access and transmit live event information 180-e, context information 182-f, or some combination thereof to a content publisher external to the live event information reporting system 100, such as Twitter®, Facebook®, or a local media web page.

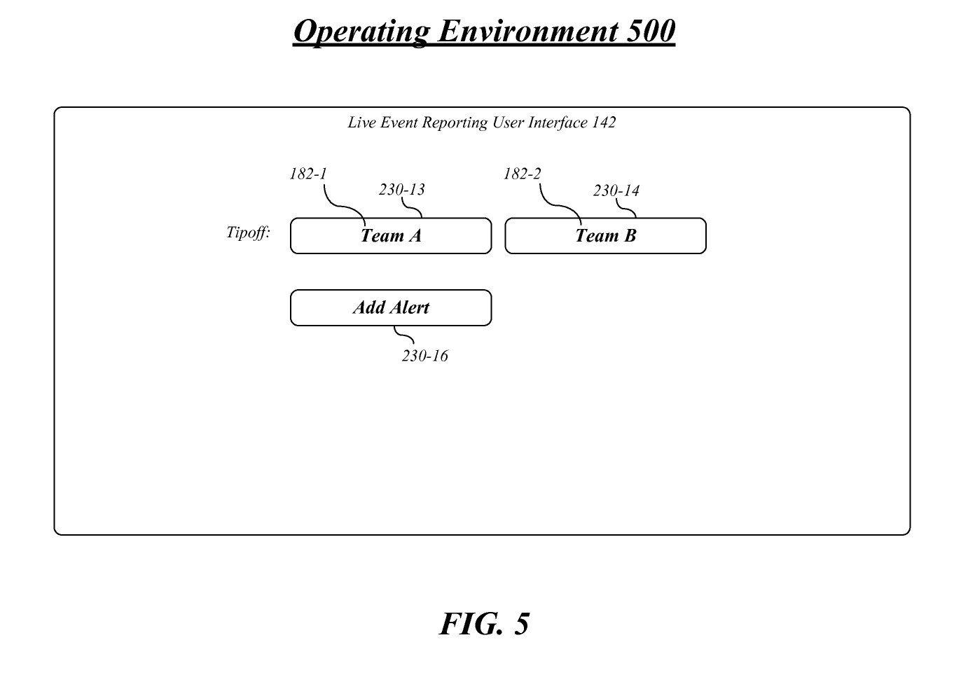

FIG. 5 illustrates an embodiment of an operating environment 500 for the live event information reporting system 100. More particularly, the operating environment 500 may illustrate an exemplary live event reporting user interface 142 for reporting the tipoff of a basketball sporting event. Event information elements 230-13, 230-14 may be displayed to select which team won the opening tipoff of a basketball sporting event and may be configured to display team names obtained from context information 182-1, 182-2 associated with the basketball sporting event. As shown in FIG. 5, embodiments may provide event information elements 230-16 configured to transmit the entered live event information 180-e (i.e., which team won the tipoff), for example, as an “Add Alert” 230-16 selection button communicating that an event has occurred in the game. In the example depicted in FIG. 5, the event comprises the opening tipoff, indicating that the game has begun.

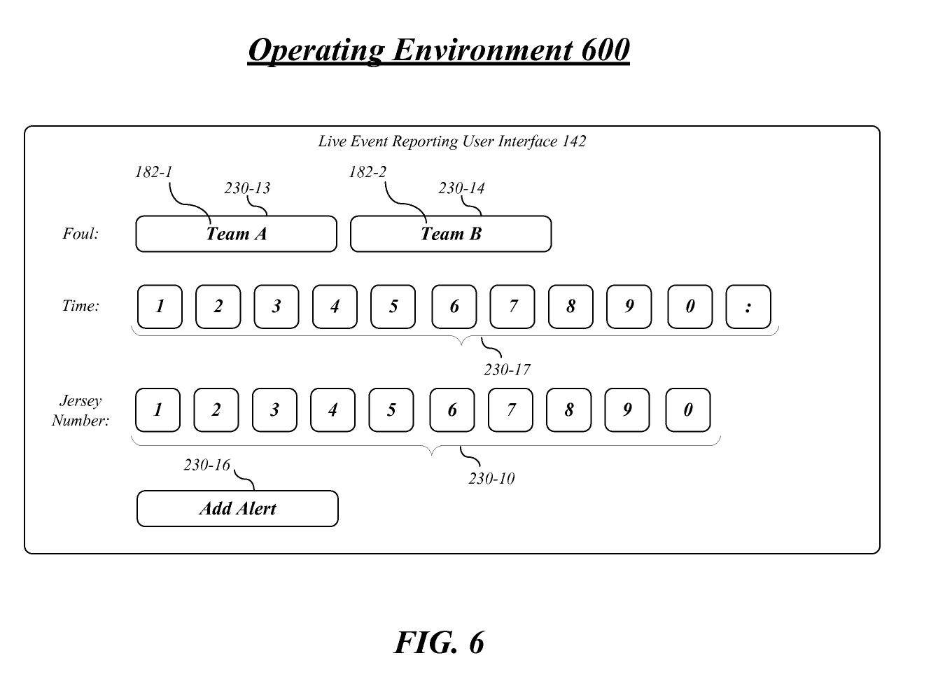

FIG. 6 illustrates an embodiment of an operating environment 600 for the live event information reporting system 100. More particularly, the operating environment 600 may illustrate an exemplary live event reporting user interface 142 for reporting a foul during a basketball sporting event. Event information elements 230-13, 230-14 may be displayed to select which team committed the foul and may be configured to display team names obtained from context information 182-1, 182-2 associated with the basketball sporting event. The game time when the foul occurred 230-17 and the jersey number of the fouling player 230-10 may be entered when reporting a foul. The live event information 180-e (e.g., fouling team, time, and jersey number) for the foul may be communicated to the live event information reporting application 140 responsive to selection of the “Add Alert” 230-16 event information element.

The live event reporting user interface 142 is not limited to the configuration shown in FIGS. 4-10 herein, as they are provided for illustrative purposes only. For example, the foul reporting interface illustrated in FIG. 6 may be configured to include a foul description text box event information element 230-j configured to accept a textual description of the foul (e.g., “personal foul: shot made, 1 free throw”) that may be received by the live event information reporting application 140 as live event information 180-e.

A user may make a mistake when reporting a live event or an action may occur that removes a reported score (e.g., a penalty). As such, the live event reporting user interface 142 may be configured according to embodiments to allow a user to change a reported score. FIG. 7 illustrates an embodiment of an operating environment 700 for the live event information reporting system 100 depicting a live event reporting user interface 142 configured to allow a user to change a reported score during a sporting event. Event information elements 230-13, 230-14 may be displayed for selecting the team requiring a score adjustment, labeled utilizing context information 182-1, 182-2 associated with the sporting event. A user may select a team 230-13, 230-14 and add 230-18 or subtract 230-19 from their score accordingly. The quarter 230-20 (or other time period designation) may be specified and the live event information reporting application 140 may update the score responsive to selection of an update score 230-21 selection button.

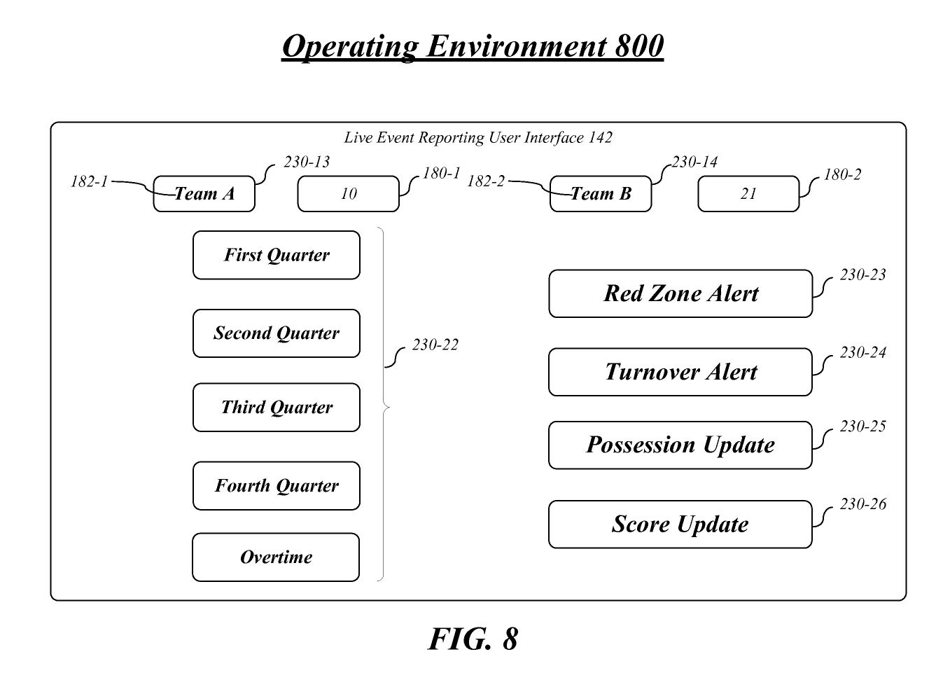

Although sporting events, and basketball sporting events in particular, have been utilized as examples herein, embodiments are not so limited. The live event information reporting application 140 may be configured for any type of live event capable of information reporting according to embodiments provided herein, particularly local and small audience events requiring members of the general public to provide updated information because they do not receive widespread media attention. Exemplary live events include, but are not limited to, football, baseball, softball, ice hockey, field hockey, soccer, wrestling, track and field, lacrosse, swimming, as well as news, entertainment, financial, and legal events. For example, FIG. 8 illustrates an embodiment of an operating environment 800 for the live event information reporting system 100 depicting a live event reporting user interface 142 configured for a football sporting event.

In FIG. 8, therein is provided event information elements 230-13, 230-14 for selecting a team participating in the sporting event, labeled utilizing context information 182-1, 182-2 associated with the sporting event. Time period selection elements 230-22 may be configured to select the current quarter (or overtime) for the football sporting event. Additional event information elements may be provided to allow a user to enter when a team has entered the red zone (e.g., inside the 20-yard line) 230-23, a turnover has occurred 230-24, change in possession 230-25, and a score update 230-26.

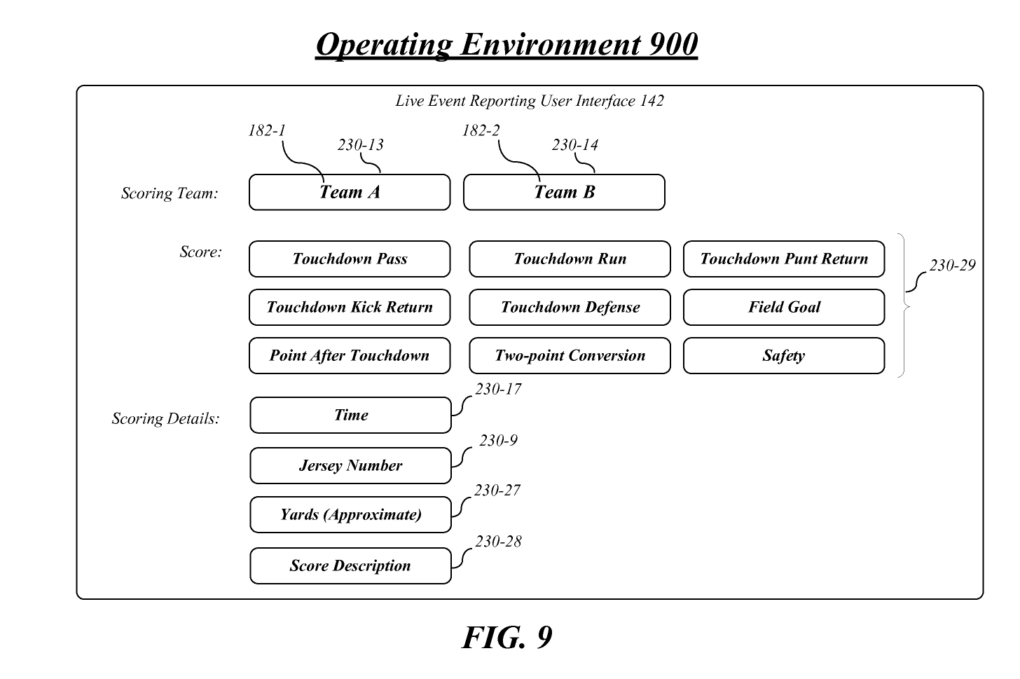

According to embodiments, selection of event information elements 230-j may invoke the display of an interface, such as a popup window, sub-screen, or sub-page, providing event information elements 230-j configured for additional live event information 180-e for the particular selection. In one embodiment, a football score interface, as depicted in FIG. 9, may be provided responsive to a user selecting the score update element 230-26. FIG. 9 illustrates an embodiment of an operating environment 900 for the live event information reporting system 100 depicting a live event reporting user interface 142 configured for updating the score of a football sporting event. In FIG. 9, therein is provided event information elements 230-13, 230-14 for selecting the scoring team, labeled utilizing context information 182-1, 182-2 associated with the sporting event. A user may select a scoring category element 230-29 to specify the type of score, such as a touchdown pass, touchdown run, touchdown punt return, touchdown kick return, touchdown made by the defense, field goal, point after touchdown (PAT), two-point conversion, and safety. More detailed information may be supplied with the score update, including the time of the score 230-17, the jersey numbers of players involved in the score 230-9, scoring play yardage 230-27, and a scoring details element 230-28 configured to accept a textual description of the scoring play.

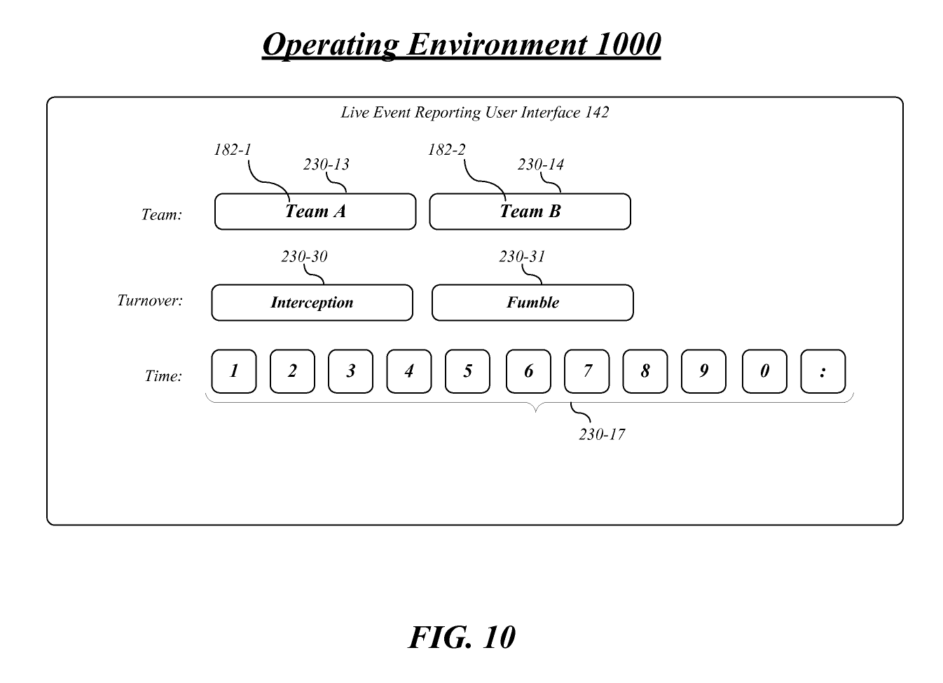

In another embodiment, a turnover interface, as depicted in FIG. 10, may be provided allowing a user to report a turnover, for example, responsive to a selecting the turnover alert element 230-24. FIG. 10 illustrates an embodiment of an operating environment 1000 for the live event information reporting system 100 depicting a live event reporting user interface 142 configured for providing turnover information for a football sporting event. In FIG. 10, therein is provided event information elements 230-13, 230-14 for selecting the team that has committed a turnover, labeled utilizing context information 182-1, 182-2 associated with the sporting event. The user may enter the type of turnover, namely, an interception 230-30 or a fumble 230-31, as well as the time of the turnover 230-17.

Users may access the live event information 180-e for a particular event utilizing a live event viewing user interface 144. For example, a user may access a web page through a web browser operative on a client 130-c configured to provide a live event viewing user interface 144 configured according to embodiments provided herein. The live event viewing user interface 144 may be configured to display context information 182-f, live event information 180-e, and other information associated with a live event in a manner formatted for easy access to the information and efficient viewing in substantially real-time.

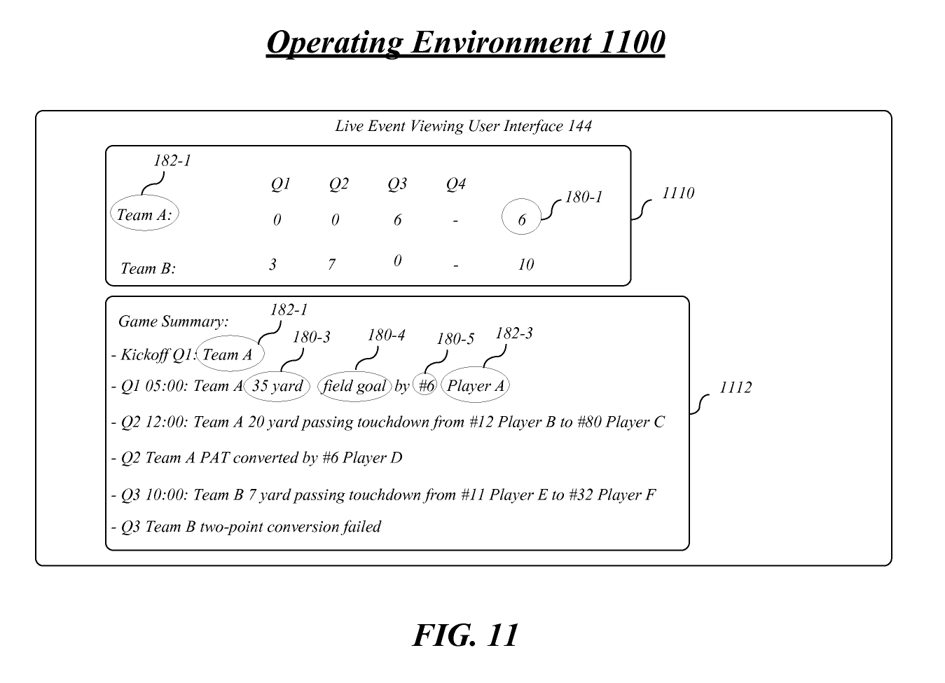

FIG. 11 illustrates an embodiment of an operating environment 1100 for the live event information reporting system 100. More particularly, the operating environment 1100 may illustrate an exemplary live event viewing user interface 144 for a football sporting event. The live event viewing user interface 144 may be comprised of game score element 1110 configured to display score information for a sporting event. The game score element 1110 may be comprised of context information 182-f, for example, team name 182-1 context information as well as live event information 180-e, for instance, current score 180-1 event information. In one embodiment, the live event viewing user interface may be comprised of a game summary element 1112 configured to display a summary of actions occurring during the live event. For example, an action displayed in the game summary element may include which team received the opening kickoff, scoring summaries, turnover summaries, and other information, such as weather conditions and attendance figures.

The information displayed in the game summary element 1112 may be comprised, inter alia, of live event information 180-e and context information 182-f. In the example embodiment depicted in FIG. 11, examples of live event information include yardage 180-3, scoring category 180-4, and the jersey number of a player associated with the scoring play 180-5, while example context information includes team names 182-1 and player names 182-3. A user may view the live event information 180-e via the live event viewing user interface 144 in substantially real-time, that is, immediately after another user has entered the live event information 180-e through the live event reporting user interface 144 while attending the live event.

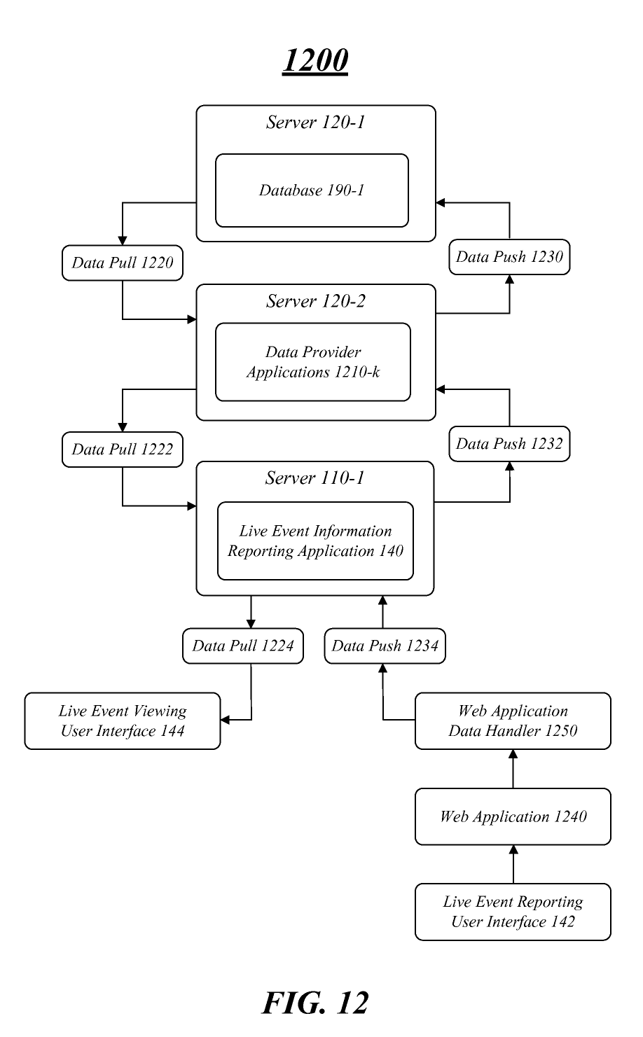

Referring to FIG. 12, therein is provided an embodiment of an operating environment 1200 for the live event information reporting system 100. As shown in FIG. 12, the live event information reporting system 100 may be comprised of or in communication with a database 190-1 and one or more data provider applications 1210-k operating on one or more servers 120-1, 120-2. According to embodiments, the database 190-1 may be an SQL database and the one or more data provider applications 1210-k may be comprised, at least in part, of a .NET web services layer. The database 190-1 and the one or more data provider applications 1210-k may interact through data pull 1220 and push operations 1230.

The live event information reporting application 140 may operate on a server 110-1 and may obtain data from the one or more data provider applications 1210-k through one or more data pull 1222 and push 1232 operations. The live event viewing user interface 144 may pull data 1224 from the live event reporting application 140, which pulled 1222 the data from the one or more data provider applications 1220-k. Live event information 180-e entered through a live event reporting user interface 142 may be submitted utilizing a web application 1240 that communicates with a web application data handler 1250 configured to push 1234 data to the live event information reporting application 140. In one embodiment, the live event reporting user interface 142 and the live event viewing user interface 144 may be comprised of ASP.NET web pages, wherein the live event reporting user interface 142 may submit game data via Asynchronous JavaScript and extensible markup language (XML) (AJAX). In this embodiment, the web application data handler 1250 may comprise a .NET web handler script (e.g., an .ashx file), which may accept data via a hypertext transfer protocol (HTTP) post.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

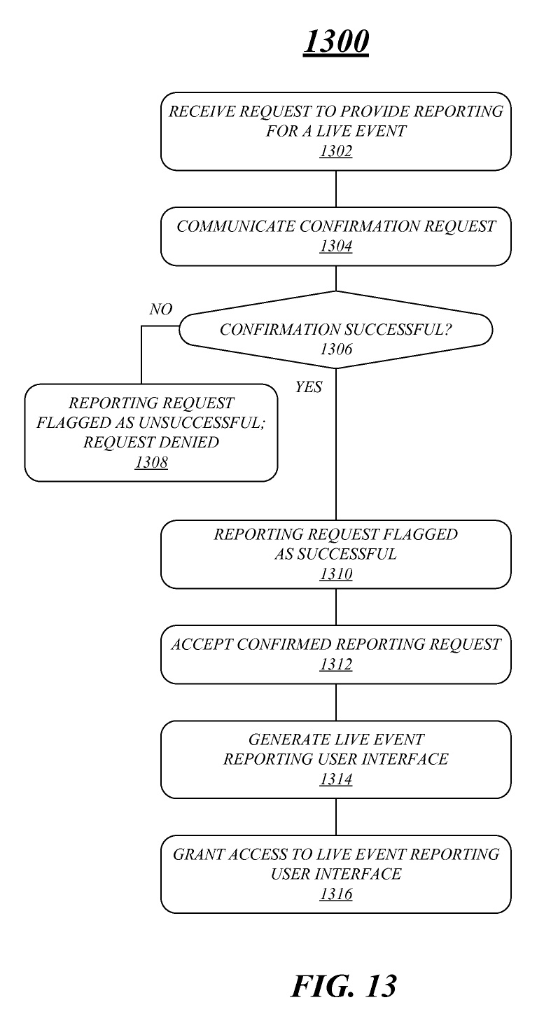

FIG. 13 illustrates one embodiment of a logic flow 1300. The logic flow 1300 may be representative of some or all of the operations executed by one or more embodiments described herein. For example, the logic flow 1300 may illustrate operations performed by the live event information reporting system 100. More specifically, the logic flow 1300 provides an example embodiment for providing user access to a live event reporting user interface 142.

In the illustrated embodiment shown in FIG. 13, the logic flow 1300 may receive a request from a registered user to provide reporting for a particular live event at block 1302. For example, the user may login to the live event information reporting system 100 or a system accessible by the live event information reporting system 100 such that the user manager component 220-5 may access the user profile 184-g of the user. The user manager component 220-5 may access information contained within the user profile 184-g, such as name, email address, and historical information involving user interaction with the live event information reporting system 100, such as previous event reporting information and any quality metrics associated with the user.

In one embodiment, the live event information reporting system 100 may select users for reporting a live event, especially if there are multiple requests to report an event, based on one or more metrics, such as the number of previous reporting events and any quality characteristics associated therewith. According to embodiments, quality characteristics may include accuracy (e.g., based on a review of the reported information), completeness (e.g., scoring a complete game, reporting all relevant events, detailed event summary information), feedback (e.g., live event viewing user interface 144 users may provide feedback for live event reporters; feedback from live event information reporting system 100 administrators), or combinations thereof.

The logic flow 1300 may communicate a confirmation request to the user requesting to report a live event at block 1304. For example, in one embodiment, the user manager component 220-5 may send an email to the email address associated with a user profile 184-g of a user requesting to report a live event. In another embodiment, the user manager component 220-5 may present a user with an interface configured to provide confirmation information or requests, such as passwords, keywords, secret questions, or other information for confirming the identity of the user.

The logic flow 1300 may determine whether the confirmation was successful at decision block 1306. For example, a user may click on a universal resource locator (URL) link provided in an email facilitated by the user manager component 220-5. In another example, the user may submit correct responses to confirmation requests, such as submitting a correct password or question response. If the confirmation was successful, the logic flow 1300 may flag the reporting request as confirmed at block 1310; otherwise, the logic flow may flag the reporting request as unsuccessful and the request is denied at block 1308.

The logic flow 1300 may accept a confirmed reporting request at block 1312. For example, the user manager component 220-5 may communicate to the live event information reporting application 140 that a user has successfully requested to report an event and may transmit user profile information required to allow a user to access and utilize a live event reporting user interface 142.

The logic flow 1300 may operate to generate a reporting interface specific for the requested event associated with the requesting user at block 1314. For example, the reporting user interface component 220-2 may obtain context information 182-f about the live event so that it may configure the live event reporting user interface 142 customized for the specific event. For example, the specific event may be given an event identifier so that the live event and any information associated therewith may be retrieved for use within the live event information reporting application 140. In addition, the live event reporting user interface may be populated with context information 182-f associated with the live event, such as participant names, location, and date and time information. In one embodiment, the reporting user interface component 220-2 may generate a live event reporting user interface 142 and associated user interfaces based on one or more templates for particular events (e.g., football, basketball, and baseball sporting event templates) automatically populated by context information 182-f. According to embodiments, each particular live event reporting user interface 142 may be associated with a user such that only that particular user may access the live event reporting user interface 142 for a specific event.

The logic flow 1300 may operate to grant access to the reporting user interface generated in response to the user request to report a live event at block 1316. For example, in one embodiment, a URL link to the live event reporting user interface 142 is communicated to an email address of the user associated with the reporting request. In another embodiment, the user is presented with a live event reporting user interface 142 window, web page, or URL link that may only be accessed by their user profile for a certain duration, such as during the scheduled event time and a certain amount of time before and after the event.

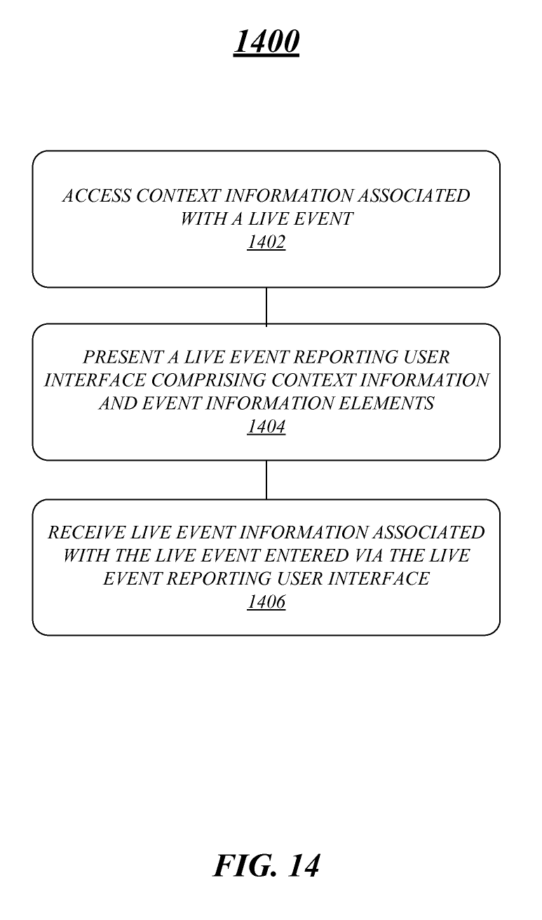

FIG. 14 illustrates one embodiment of a logic flow 1400. The logic flow 1400 may be representative of some or all of the operations executed by one or more embodiments described herein. For example, the logic flow 1400 may illustrate operations performed by the live event information reporting system 100.

In the illustrated embodiment shown in FIG. 14, the logic flow 1400 may access context information associated with a live event at block 1402. For example, the context information component 220-1 may operate to access context information 182-f stored in a database 190-h on a server 120-b.

The logic flow 1400 may present a live event reporting user interface comprising context information and event information elements at block 1404. For example, the reporting user interface component 220-2 may generate a live event reporting user interface 142 for display on a display 132 of a client 130-c. The live event reporting user interface 142 may be comprised of context information 182-f and event information elements 230-j.

The logic flow 1400 may receive live event information associated with the live event entered via the live event reporting user interface at block 1406. For example, a user may enter live event information 180-e at a live event reporting user interface 142 generated and presented by the reporting user interface component 220-2. The live event information 180-e may be received by the live event information component 220-3 for use within the live event information reporting application 140.

As shown in FIG. 15, the computing architecture 1500 comprises a processing unit 1504, a system memory 1506 and a system bus 1508. The processing unit 1504 can be any of various commercially available processors, such as those described with reference to the processor circuit 150 shown in FIG. 1.

The system bus 1508 provides an interface for system components including, but not limited to, the system memory 1506 to the processing unit 1504. The system bus 1508 can be any of several types of bus structure that may further interconnect to a memory bus (with or without a memory controller), a peripheral bus, and a local bus using any of a variety of commercially available bus architectures. Interface adapters may connect to the system bus 1508 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1500 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1506 can include non-volatile memory 1510 and/or volatile memory 1512. A basic input/output system (BIOS) can be stored in the non-volatile memory 1510.

The computer 1502 may include various types of computer-readable storage media in the form of one or more lower speed memory units, including an internal (or external) hard disk drive (HDD) 1514, a magnetic floppy disk drive (FDD) 1516 to read from or write to a removable magnetic disk 1518, and an optical disk drive 1520 to read from or write to a removable optical disk 1522 (e.g., a CD-ROM or DVD). The HDD 1514, FDD 1516 and optical disk drive 1520 can be connected to the system bus 1508 by a HDD interface 1524, an FDD interface 1526 and an optical drive interface 1528, respectively. The HDD interface 1524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1510, 1512, including an operating system 1530, one or more application programs 1532, other program modules 1534, and program data 1536. In one embodiment, the one or more application programs 1532, other program modules 1534, and program data 1536 can include, for example, the various applications and/or components of the system 100.

A user can enter commands and information into the computer 1502 through one or more wire/wireless input devices, for example, a keyboard 1538 and a pointing device, such as a mouse 1540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1504 through an input device interface 1542 that is coupled to the system bus 1508, but can be connected by other interfaces such as a parallel port, IEEE 1394 serial port, a game port, a USB port, an IR interface, and so forth.

A monitor 1544 or other type of display device is also connected to the system bus 1508 via an interface, such as a video adaptor 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer 1548. The remote computer 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wire/wireless connectivity to a local area network (LAN) 1552 and/or larger networks, for example, a wide area network (WAN) 1554. Such LAN and WAN networking environments are commonplace in offices and companies, and facilitate enterprise-wide computer networks, such as intranets, all of which may connect to a global communications network, for example, the Internet.

When used in a LAN networking environment, the computer 1502 is connected to the LAN 1552 through a wire and/or wireless communication network interface or adaptor 1556. The adaptor 1556 can facilitate wire and/or wireless communications to the LAN 1552, which may also include a wireless access point disposed thereon for communicating with the wireless functionality of the adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wire and/or wireless device, connects to the system bus 1508 via the input device interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

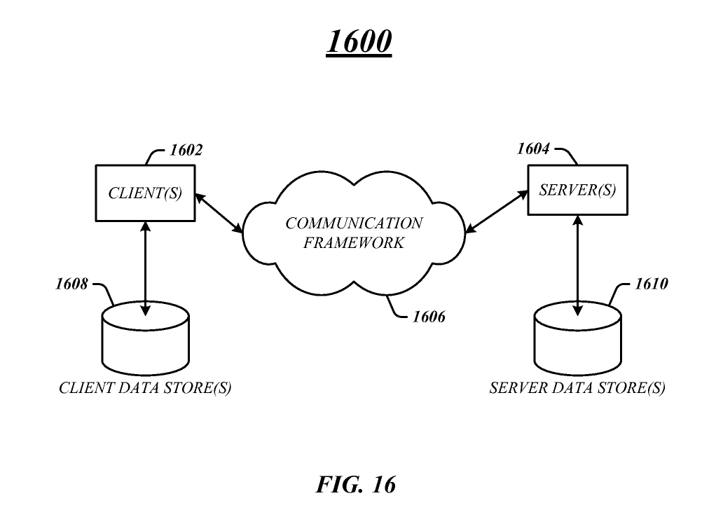

FIG. 16 illustrates a block diagram of an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, and so forth. The embodiments, however, are not limited to implementation by the communications architecture 1600.

As shown in FIG. 16, the communications architecture 1600 comprises includes one or more clients 1602 and servers 1604. The clients 1602 may implement the client device 150. The servers 1604 may implement summary engine device 110, and publication site 140. The clients 1602 and the servers 1604 are operatively connected to one or more respective client data stores 1608 and server data stores 1610 that can be employed to store information local to the respective clients 1602 and servers 1604, such as cookies and/or associated contextual information.

The clients 1602 and the servers 1604 may communicate information between each other using a communication framework 1606. The communications framework 1606 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 1602 and the servers 1604 may include various types of standard communication elements designed to be interoperable with the communications framework 1606, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 1602 and a server 1604 can be in the form of a data packet adapted to be transmitted between two or more computer processes. The data packet may include a cookie and/or associated contextual information, for example.

The various elements of the live event information reporting system 100 as previously described with reference to FIGS. 1-16 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
accessing, by a processor circuit accessible by a computing device, context information associated with one or more live events;
presenting a live event reporting user interface for display on a computing device display, the live event reporting user interface configured to display the context information and one or more event information elements corresponding to the one or more live events; and
receiving, at a transceiver accessible by the processor circuit, live event information associated with the one or more live events entered via the event information elements.

2. The method of claim 1, wherein the one or more live events comprise a sporting event.

3. The method of claim 2, wherein the one or more information elements comprise graphical user interface elements configured to report at least one of:
a team;
a score;
a jersey number;
a time; and
a time period.

4. The method of claim 3, wherein the sporting event comprises a basketball sporting event, the one or more graphical user interface elements being configured to report at least one of:
a tipoff winner;
a three-point basket;
a two-point basket;
a one-point basket;
a foul;
a time associated with the foul;
a timeout;
a time associated with the timeout;
a score adjustment comprising a subtract from score adjustment and an add to score adjustment; and
a time period.

5. The method of claim 3, wherein the sporting event comprises a football sporting event, the one or more graphical user interface elements being configured to report at least one of:
a play type;
a touchdown;
a field goal;
a point after touchdown;
a two-point conversion;
a safety;
a scoring summary; and
a turnover.

6. The method of claim 1, further comprising presenting a live event viewing user interface configured to display context information and live event information received for the one or more live events in substantially real-time.

7. The method of claim 1, further comprising retrieving context information based on received live event information.

8. The method of claim 7, wherein the live event information comprises a jersey number and the context information comprises a player name associated with the jersey number.

9. The method of claim 1, further comprising managing user access to the live event reporting user interface, wherein managing comprises:
receiving one or more requests to access a live event reporting user interface for a live event;
confirming a user associated with the one or more requests;
denying access to the live event reporting user interface for non-confirmed users; and
granting access to the live event reporting user interface for confirmed users.

10. An apparatus, comprising:
a transceiver;
a processor circuit coupled to the transceiver; and
a memory unit coupled to the processor circuit, the memory unit to store a live event information reporting application operative on the processor circuit to provide user interfaces for reporting and viewing information reported for live events, the live event information reporting application comprising:
a context information component operative to access context information associated with one or more live events;
a reporting user interface component operative to present a live event reporting user interface, the live event reporting user interface configured to display the context information and one or more event information elements corresponding to the one or more live events; and
a live event information component operative to receive live event information associated with the one or more live events entered via the event information elements.

11. The apparatus of claim 10, wherein the one or more live events comprise a sporting event.

12. The apparatus of claim 11, wherein the one or more information elements comprise graphical user interface elements configured to report at least one of:
a team;
a score;
a jersey number;
a time; and
a time period.

13. The apparatus of claim 12, wherein the sporting event comprises a basketball sporting event, the one or more graphical user interface elements being configured to report at least one of:
a tipoff winner;
a three-point basket;
a two-point basket;
a one-point basket;
a foul;
a time associated with the foul;
a timeout;
a time associated with the timeout;
a score adjustment comprising a subtract from score adjustment and an add to score adjustment; and
a time period.

14. The apparatus of claim 12, wherein the sporting event comprises a football sporting event, the one or more graphical user interface elements being configured to report at least one of:
a play type;
a touchdown;
a field goal;
a point after touchdown;
a two-point conversion;
a safety;
a scoring summary; and
a turnover.

15. The apparatus of claim 10, further comprising a viewing user interface component operative to present a live event viewing user interface configured to display context information and live event information received for the one or more live events in substantially real-time.

16. The apparatus of claim 10, the context information component operative to retrieve context information based on received live event information.

17. The apparatus of claim 16, wherein the live event information comprises a jersey number and the context information comprises a player name associated with the jersey number.

18. The apparatus of claim 10, further comprising a user manager component operative to manage user access to the live event reporting user interface, wherein to manage comprises:
receiving one or more requests to access a live event reporting user interface for a live event;
confirming a user associated with the one or more requests;
denying access to the live event reporting user interface for non-confirmed users; and
granting access to the live event reporting user interface for confirmed users.

19. A machine-readable storage medium comprising instructions that when executed cause a computing system to:
access context information associated with one or more live events;
present a live event reporting user interface for display on a computing device display, the live event reporting user interface configured to display the context information and one or more event information elements corresponding to the one or more live events; and
receive live event information associated with the one or more live events entered via the event information elements.

20. The machine-readable storage medium of claim 19, wherein the one or more live events comprise a sporting event.

21. The machine-readable storage medium of claim 19, further comprising instructions that when executed cause the computing system to present a live event viewing user interface configured to display context information and live event information received for the one or more live events in substantially real-time.

22. The machine-readable storage medium of claim 19, further comprising instructions that when executed cause the computing system to:
manage user access to the live event reporting user interface, wherein to manage comprises:
receiving one or more requests to access the live event reporting user interface for a live event;
confirming a user associated with the one or more requests;
denying access to the live event reporting user interface for non-confirmed users; and
granting access to the live event reporting user interface for confirmed users.

23. An apparatus, comprising:
a transceiver;
a processor circuit coupled to the transceiver; and
a memory unit coupled to the processor circuit, the memory unit to store a live event information reporting application operative on the processor circuit to provide a user interfaces for reporting information for live events, the live event information reporting application comprising:
a reporting user interface component operative to access a live event reporting user interface, the live event reporting user interface configured to provide context information and one or more event information elements corresponding to one or more live events; and
a live event information component operative to transmit, by the transceiver, live event information associated with the one or more live events entered via the event information elements to one or more live event information receivers.

24. The apparatus of claim 23, further comprising a user manager component operative to request access to the live event reporting user interface, wherein requesting comprises:
transmitting one or more requests to access a live event reporting user interface for a live event; and
transmitting one or more confirmation replies responsive to receiving one or more confirmation requests configured to deny or grant access to the live event reporting user interface.
